(19) United States
(12) Patent Application Publication
(10) Pub. No.: US 2008/0125193 A1
(43) Pub. Date: May 29, 2008

(54) Input apparatus and mobile device having the same

(75) Inventors: Min-Woong Choi, Seongnam-si (KR); Ho-Chul Joung, Yongin-si (KR); Sung-Hwan Yim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/987,283

(22) Filed: Nov. 28, 2007

(30) Foreign Application Priority Data
Nov. 29, 2006 (KR) 10-2006-0119278

(51) Int. Cl. H04M 1/00

(52) U.S. Cl. 455/575.1

(57) ABSTRACT

An input apparatus and a mobile device having the input apparatus are disclosed. By using an input apparatus, incorporated in a terminal comprising a circuit board and a case that forms an overall outer shape, which includes: a maneuver part, of which one side faces one side of the circuit board; a magnet coupled to the maneuver part; a magnetism sensor, which is coupled to the other side of the circuit board, and which detects magnetic forces generated by the magnet; and a housing, which is coupled to the case, and which covers at least a portion of the maneuver part, the thicknesses of parts can be reduced and individual parts can freely be replaced, as the housing is detachably coupled to the case by hooks.

### CROSS-REFERENCE TO RELATED APPLICATIONS

This application claims the benefit of Korean Patent Application No. 10-2006-0119278 filed with the Korean Intellectual Property. Office on Nov. 29, 2006, the disclosure of which is incorporated herein by reference in its entirety.

### BACKGROUND

1. Technical Field

The present invention relates to an input apparatus and a mobile device that includes the input apparatus.

2. Description of the Related Art

An input apparatus may be an auxiliary apparatus installed in various mobile terminals, such as a mobile phone or a remote controller, etc., for receiving input from the user. As current trends demand smaller and thinner mobile terminals, the input apparatus is also becoming smaller and thinner, and developments are being made to allow easier maneuver by the user.

However, in a pointing device according to prior art, because the maneuver part is affixed to the upper box or the circuit board by an attachment or adhesion means, etc., not only is the extra attachment or adhesion means additionally required, but also the part cannot be separated once it is affixed. Thus, in cases where a replacement of a part is required, such as when the part is broken, etc., there is the difficulty that all of the circuit board, etc., has to be replaced.

### SUMMARY

An aspect of the invention is to provide a thin input apparatus and a mobile device that includes the input apparatus, with which the thicknesses of parts can be reduced and individual parts can freely be replaced, as the housing is detachably installed to the main circuit board of the terminal.

One aspect of the invention may provide an input apparatus, to be incorporated in a terminal comprising a circuit board and a case that forms an overall outer shape, which includes: a maneuver part, of which one side faces one side of the circuit board; a magnet coupled to the maneuver part; a magnetism sensor, which is coupled to the other side of the circuit board, and which detects magnetic forces generated by the magnet; and a housing, which is coupled to the case, and which covers at least a portion of the maneuver part.

A contact part may be formed on the maneuver part that provides a surface of contact for a user, an opening may be formed in the housing that exposes the contact part to the exterior, and the opening may be made to be bigger than the contact part.

The input apparatus can further include an elastic body, coupled to one side of the maneuver part, that supplies an elastic force to the maneuver part.

A plurality of coupling protrusions may be formed on the housing, while a plurality of coupling indentations may be formed in the inner wall of the case, in correspondence with the coupling protrusions. The end of at least one coupling protrusion may be shaped as a hook protruding outwards.

Another aspect of the invention may provide a mobile device, which includes: a maneuver part; a magnet coupled to the maneuver part; a circuit board, one side of which faces one side of the maneuver part; a magnetism sensor, which is coupled to the other side of the circuit board, and which detects magnetic forces generated by the magnet; a housing that covers at least a portion of the maneuver part; and a case, which is coupled to the housing, and which forms an overall external shape.

In certain embodiments, the mobile device can further include an elastic body, coupled to one side of the maneuver part, that supplies an elastic force to the maneuver part, and can further include a dome switch coupled to the one side of the circuit board, while a protrusion directed towards the dome switch may be formed on the elastic body in a predetermined position corresponding to the dome switch.

A contact part may be formed on the maneuver part that provides a surface of contact for a user, an opening may be formed in the housing that exposes the contact part to the exterior, and the opening may be made to be bigger than the contact part.

A plurality of coupling protrusions may be formed on the housing, while a plurality of coupling indentations may be formed in the inner wall of the case, in correspondence with the coupling protrusions. The end of at least one coupling protrusion may be shaped as a hook protruding outwards.

Additional aspects and advantages of the present invention will be set forth in part in the description which follows, and in part will be obvious from the description, or maybe learned by practice of the invention.

### BRIEF DESCRIPTION OF THE DRAWINGS

FIG. 1 is a cross-sectional view illustrating an input apparatus according to an embodiment of the present invention.

FIG. 2 is an exploded perspective view illustrating a mobile device according to another embodiment of the present invention.

FIG. 3 is a schematic drawing illustrating the magnetism sensor shown in FIG. 1.

### DETAILED DESCRIPTION

The input apparatus and mobile device according to certain embodiments of the invention will be described below in more detail with reference to the accompanying drawings, in which those components are rendered the same reference number that are the same or are in correspondence, regardless of the figure number, and redundant explanations are omitted.

First, embodiments of an input apparatus according to one aspect of the invention will be described below.

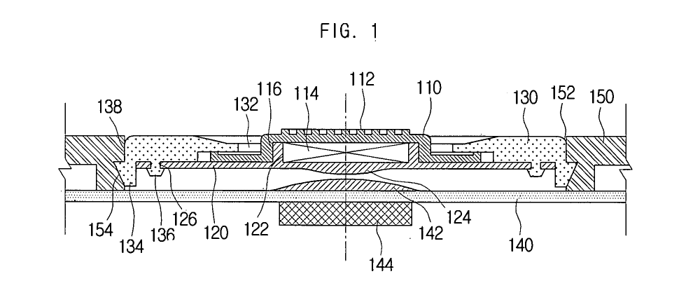

FIG. 1 is a cross-sectional view illustrating an input apparatus 100 according to an embodiment of the present invention. In FIG. 1 are illustrated a maneuver part 110, a contact part 112, a magnet 114, a holding recess 116, an elastic body 120, a mounting part 122, a protruding part 124, a housing 130, an opening 132, coupling protrusions 134, 136, a perimeter wall 138, a circuit board 140, a dome switch 142, a magnetism sensor 144, a case 150, and coupling indentations 154.

The maneuver part 110 can be the portion which a user can maneuver in any direction of 360 degrees to input a signal through the input apparatus 100 according to this embodiment. The maneuver part 110 may have a contact part 112 formed in the center, which serves as the point of contact with the user's finger, and may have a holding recess 116 in the reverse side, which serves to hold the magnet 114, as will be described later in further detail.

The contact part 112 may be made of a material such as aluminum, for instance, that has a certain degree of rigidity and a light weight, while several ring-shaped grooved protrusions can be formed in the surface of the contact part 112 for better contact with the finger. In addition, the surface of the contact part 112 can be coated with a material that provides a pleasant tactile feel.

The magnet 114 delivers magnetic forces to sensors, such as Hall sensors (not shown), for example, included in the magnetism sensor 144, to allow the magnetism sensor 144 to detect the displacement of the magnet 114 or the maneuver part 110. The magnet 114 can be held in the holding recess 116 formed in the maneuver part 110. The magnet 114 may be held directly in the holding recess 116, but other arrangements can also be used. For example, the magnet 114 can be mounted on the mounting part 122 formed on the elastic body 120 described later, and held together with the mounting part 122 in the holding recess 116. An example of the magnet 114 would include a permanent magnet.

The elastic body 120 can serve to return the maneuver part 110, which may have moved in a particular direction, to its original position. The elastic body 120 can be made of a material, such as rubber, for example, that is high in elasticity and high in toughness. While rubber is presented in this embodiment as the material for the elastic body 120, other materials having elasticity may obviously be employed, after various modifications as necessary.

Coupling holes 126 can be formed in this elastic body 120 for coupling with the housing 130, while coupling protrusions 136 can be formed in the housing 130 in correspondence with the coupling holes 126 formed in the elastic body 120, by which the elastic body 120 and the housing 130 may be coupled to each other. Obviously, the method of coupling the elastic body 120 and the housing 130 may vary according to design requirements.

As described above, the magnet 114 can be arranged to be held by the elastic body 120, and then the magnet 114 and portions of the elastic body 120 that hold the magnet 114 can be held in the holding recess 116 formed in the maneuver part 110. For this, the mounting part 122 can be formed in the center of the elastic body 120 on which to mount the magnet 114. The mounting part 122 can have a protruding shape.

Also, a protruding part 124 may be formed on the reverse side of the elastic body 120, to more efficiently be in contact with the dome switch 142, which will be described later.

The magnetism sensor 144 may serve to detect the movement of the magnet 114 or maneuver part 110, and may be coupled to the lower surface of the circuit board 140. The magnetism sensor 144 may include, for example, four Hall sensors arranged in particular distances from the central axis. The movement of the magnet 114 or maneuver part 110 can be detected by the four Hall sensors, and the detected signal can be transferred to the circuit board 140, for signal processing with regards the movement of the magnet 114 or maneuver part 110.

While four Hall sensors are presented in this embodiment, the number and type of sensors may obviously vary according to design requirements.

The housing 130 may serve to protect the maneuver part 110, magnet 114, elastic body 120, etc., from the exterior, and may be shaped as a container having a perimeter wall 138 and an opening 132. A plurality of coupling protrusions 134 that will be coupled to the case 150, as described later, may be formed along the perimeter wall 138 in particular intervals, where the end of a coupling protrusion 134 can be shaped as a hook directed outwards.

In the center of the housing 130, an opening 132 is formed such that a portion of the maneuver part 110, including the contact part 112, is exposed. The opening 132 can serve to define the movement range of the maneuver part 110, more specifically, the contact part 112. For this, the opening 132 can be made bigger than the contact part 112.

The circuit board 140 may have the dome switch 142 on its upper surface, and the magnetism sensor 144 on its lower surface. For efficient operation, the contact part 112 of the maneuver part 110, the dome switch 142, and the magnetism sensor 144 can be formed along the same axis.

The dome switch 142 may be formed on the upper surface of the circuit board 140, so that an input can be made not only by the movement of the magnet 114, but also by applying pressure on the maneuver part 110. As described above, for more efficient functioning, the dome switch 142 can be formed along the same axis as the maneuver part 110.

The circuit board 140 can be the circuit board of the terminal in which the input apparatus is to be incorporated. As such, by utilizing the circuit board of the terminal in which the input apparatus according to this embodiment is incorporated, the thickness of the input apparatus can be reduced, whereby the terminal in which the input apparatus according to this embodiment is incorporated may also be reduced in thickness.

The case 150 serves to carry and protect the components of the terminal incorporating the input apparatus according to this embodiment, while at the same time forming the overall outer shape.

A hole 152 may be formed in the case 150 that corresponds with the housing 130 described above, such that the housing 130 and portions of the maneuver part 110 including the contact part 112 may be exposed to the exterior. In the inner wall of the case 150 formed by such a hole 152, there may be coupling indentations 154 formed, which correspond with the coupling protrusions 134 formed on the perimeter wall 138 of the housing 130. The coupling of the indentations 154 and protrusions 134 allow the housing 130 and the case 150 to be coupled to each other.

For an easier assembly of the housing 130 and case 150, the end of a coupling protrusion 134 can be shaped as a hook protruding outwards, i.e. towards the inner wall of the case 150. By way of such a structure, the housing 130 and case 150 can be coupled efficiently by inserting the housing 130 from above the hole formed in the case 150.

Also, by having the housing 130 coupled to the case 150 and not the circuit board 140, no additional processing procedures may be needed, such as of forming through-holes in the circuit board 140 for coupling with the housing 130. Considering how through-holes may act as obstacles in forming circuit patterns on the circuit board 140 or in mounting various components, having the housing 130 coupled with the case 150 and obviating the need to form through-holes in the circuit board 140 can be an important factor in increasing efficiency.

The composition of the input apparatus according to embodiments of the invention has been described above, and the operation of the input apparatus according to embodiments of the invention will now be described below.

When the contact part 112 or the maneuver part 110 is maneuvered in a certain direction by the user, the magnet 114 held in the maneuver part 110 may be moved as well. The movement of the magnet 114 induces changes in magnetic forces, and as these changes can be detected by the magnetism sensor 144, the movement of the magnet 114 or maneuver part 110 can also be detected. The movement of the maneuver part 110 thus detected may be transferred through the circuit board 140 to be displayed by way of a cursor, etc., in the display unit of the terminal.

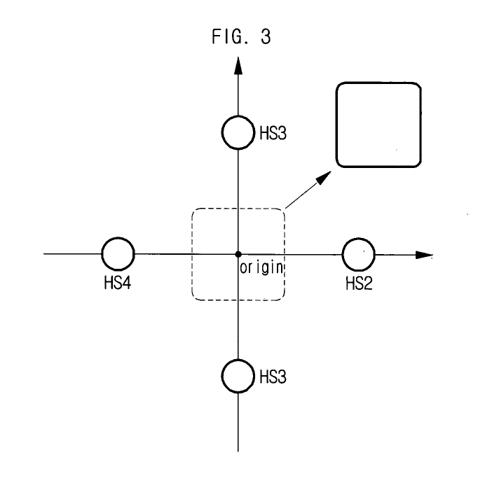

FIG. 3 is a schematic drawing illustrating the magnetism sensor shown in FIG. 1. The portion represented in FIG. 3 as the origin may be the position aligned with the central axis of the maneuver part 110. FIG. 3 illustrates the example where the magnet positioned at the origin has been moved in an upward right direction.

While the drawing represents Hall sensors (HS1, HS2, HS3, HS4) located with substantial distances to the outwards of the magnet for convenience in understanding and explanation, the arrangement and type of sensors may vary according to design requirements, as already mentioned above.

When the magnet 114 is positioned at the origin, as depicted by the dotted lines, the four Hall sensors may detect equal amounts of magnetic force, but when the magnet is positioned to the top right, as depicted by the solid lines, the Hall sensors closer to the magnet (HS1, HS2) may detect relatively greater magnetic forces, while the Hall sensors further from the magnet (HS3, HS4) may detect relatively smaller magnetic forces.

As such, the intensity of magnetic forces detected by each Hall sensor may vary according to the movement of the magnet 114, and such changes in the detected magnetic forces makes it possible to detect the movement and displacement of the magnet 114. Thus, the movement and displacement of the maneuver part 110 can be detected.

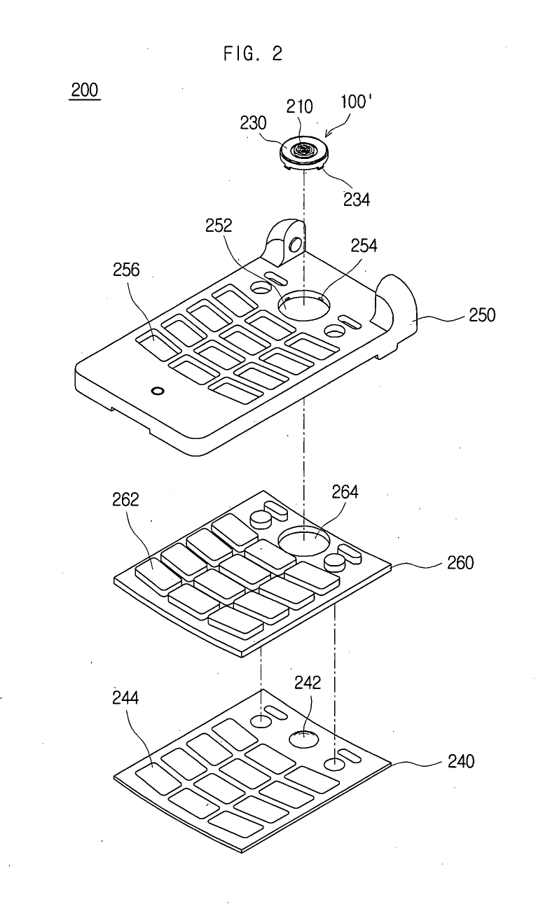

Next, embodiments of a mobile device according to another aspect of the invention will be described below with reference to FIG. 2. The mobile device 200 according to these embodiments incorporate the input apparatus described above, and in describing the mobile device according to these embodiments, detailed descriptions on the input apparatus will not be repeated.

FIG. 2 is an exploded perspective view illustrating a mobile device according to another embodiment of the present invention. In FIG. 2 are illustrated an input apparatus 100′, a maneuver part 210, a housing 230, coupling protrusions 234, a circuit board 240, a dome switch 242, switches 244, a case 250, coupling indentations 254, a key panel 260, and buttons 262.

The circuit board 240 may have several switches 244 and the dome switch 242 on its front side that enable major functions, and may have a magnetism sensor (not shown) and several other electronic components coupled on its reverse side.

The key panel 260 can be made of an elastic material such as synthetic rubber, etc., and may be shaped to have several elastically deformable buttons 262 protruding from its surface in positions corresponding to the several switches formed on the circuit board 240. Each of the buttons 262 may be arranged to substantially overlap each of the switches 244 on the circuit board 240.

Also, in order that the dome switch 242 formed on the circuit board 240 can be pressed using the maneuver part 210, a hole 264 can be formed in a position of the key panel 260 that corresponds with the maneuver part 210 and the dome switch 242.

The case 250 may serve to carry the above-mentioned circuit board 240 and key panel 260, etc., and protect these from the exterior, and may be made of materials such as synthetic resin or metal. FIG. 2 illustrates only an upper case 250, a part of a case formed by upper and lower portions. A lower case (not shown) that corresponds with the upper case 250 can be coupled to the lower surface of the circuit board 240.

In the case 250 may be formed several button holes 256, through which the buttons 262 can pass and be exposed to the exterior, as well as an opening 252, through which a portion of the input apparatus 100′ can be exposed to the exterior. The user may maneuver the buttons 262 and input apparatus 100′ exposed through the button holes 256 and the opening 252, to activate the desired functions.

Coupling protrusions 234 may be formed on the perimeter wall of the input apparatus 100′, while coupling indentations 254 corresponding to the coupling protrusions 234 may be formed in the inner wall formed by the opening 252, which allow the input apparatus to be coupled to the case 250. As already described above, in order to facilitate the coupling between the input apparatus 100′ and the case 250, the ends of the coupling protrusions 234 can have hook-like shapes protruding outwards, i.e. towards the inner wall.

While this embodiment illustrates a key panel 260 which has several buttons 262 and which is separate from the case 250, the key panel and the case may obviously be formed as a single integrated body, and the shapes, etc., of the case and key panel may vary according to design requirements.

Using the input apparatus and the mobile device incorporating the input apparatus according to certain embodiments of the invention as set forth above, the thicknesses of parts can be reduced and individual parts can freely be replaced, as the housing is detachably coupled to the case by hooks.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. An input apparatus to be incorporated in a terminal comprising a circuit board and a case that forms an overall outer shape, the input apparatus comprising:
a maneuver part having one side thereof facing one side of the circuit board;
a magnet coupled to the maneuver part;
a magnetism sensor coupled to the other side of the circuit board and configured to detect a magnetic force generated by the magnet; and
a housing coupled to the case and covering at least a portion of the maneuver part.

2. The input apparatus of claim 1, wherein the maneuver part has a contact part formed thereon, the contact part providing a surface of contact for a user,
the housing has an opening formed therein, the opening exposing the contact part to the exterior, and
the opening is bigger than the contact part.

3. The input apparatus of claim 1, further comprising an elastic body coupled to one side of the maneuver part and configured to supply an elastic force to the maneuver part.

4. The input apparatus of claim 1, wherein the housing has a plurality of coupling protrusions formed thereon, and
the case has a plurality of coupling indentations on an inner wall thereof, the coupling indentations formed in correspondence with the coupling protrusions.

5. The input apparatus of claim 4, wherein at least one of the coupling protrusions has an end portion thereof shaped as a hook protruding outwards.

6. A mobile device comprising:
a maneuver part;
a magnet coupled to the maneuver part;
a circuit board having one side facing one side of the maneuver part;
a magnetism sensor coupled to the other side of the circuit board and configured to detect a magnetic force generated by the magnet;
a housing covering at least a portion of the maneuver part; and
a case coupled to the housing and forming an overall external shape.

7. The mobile device of claim 6, further comprising an elastic body coupled to one side of the maneuver part and configured to supply an elastic force to the maneuver part.

8. The mobile device of claim 7, further comprising a dome switch coupled to the one side of the circuit board.

9. The mobile device of claim 8, wherein a protrusion is formed on the elastic body in a predetermined position corresponding to the dome switch, the protrusion directed towards the dome switch.

10. The mobile device of claim 6, wherein the maneuver part has a contact part formed thereon, the contact part providing a surface of contact for a user,
the housing has an opening formed therein, the opening exposing the contact part to the exterior, and
the opening is bigger than the contact part.

11. The mobile device of claim 6, wherein the housing has a plurality of coupling protrusions formed thereon, and
the case has a plurality of coupling indentations on an inner wall thereof, the coupling indentations formed in correspondence with the coupling protrusions.

12. The mobile device of claim 11, wherein at least one of the coupling protrusions has an end portion thereof shaped as a hook protruding outwards.
